(19) United States
(12) Patent Application Publication
(10) Pub. No.: US 2025/0327703 A1
(43) Pub. Date: Oct. 23, 2025

(54) VIBRATORY SYSTEM FOR PROTECTING A SENSOR AGAINST BIOFOULING BY AQUATIC MICROORGANISMS

(71) Applicants: COMMISSARIAT A L'ENERGIE ATOMIQUE ET AUX ENERGIES ALTERNATIVES, PARIS (FR); UNIVERSITE DE TOULON, LA GARDE (FR)

(72) Inventors: Hugues BRISSET, GRENOBLE CEDEX (FR); Fabrice CASSET, GRENOBLE CEDEX (FR)

(21) Appl. No.: 19/187,244

(22) Filed: Apr. 23, 2025

(30) Foreign Application Priority Data
Apr. 23, 2024 (FR) FR2404198

(51) Int. Cl. G01J 1/02; B08B 7/02; B08B 13/00; B08B 17/02

(52) U.S. Cl. CPC G01J 1/0252; B08B 7/02; B08B 13/00; B08B 17/02

(57) ABSTRACT

A system for controlling biofouling by microorganisms, adapted to cooperate with a measurement device adapted to be immersed in a liquid, the measurement device including a fouling surface able to allow measurement, the system being configured to cover the fouling surface and including a membrane and an actuator to vibrate the membrane.

### CROSS-REFERENCE TO RELATED APPLICATIONS

This application claims priority to French Patent Application No. 2404198, filed Apr. 23, 2024, the entire content of which is incorporated herein by reference in its entirety.

### FIELD

The technical field of the invention is that of measurement devices in liquid media which are prone to biofouling by microorganisms.

In particular, the invention relates to a system for controlling biofouling by microorganisms.

### BACKGROUND

Equipment used in a liquid environment, in which it is partially or totally immersed, is prone to biofouling by micro-organisms (for example bacteria, algae, molluscs, etc.) due to their deposition onto and adhesion to the surfaces of said equipment after only a few minutes of immersion.

When the equipment in question is measurement equipment comprising a sensor, measurements it takes are disturbed, or even distorted or impossible to perform, because of the accumulation of these microorganisms and their growth, especially on and around the portion of the sensor used for measurement. This is typically the case for an optical sensor where the emission and sensing of the light wave are disturbed by fouling on the sensor window through which the light wave propagates.

It is known to apply, to the surface to be protected, a coating comprising biocidal chemical agents whose toxicity repels and destroys micro-organisms deposited thereon. However, these chemical coatings are polluting and are not durable, as the amount of biocides in the coating is not unlimited. Once this amount has been used up, the coating becomes ineffective against biofouling.

It is also known to use mechanical devices to prevent deposition of microorganisms, for example, a shutter protecting the measurement surface which only opens when taking a measurement. Mechanisms are also known which remove the deposit of microorganisms from the surface in question, for example a “windscreen wiper” type mechanism. However, these solutions are also sensitive to biofouling and require regular maintenance to take off deposit of micro-organisms.

Furthermore, sensors have been known to be fitted with a device designed to vibrate the portion of the sensor being used to make the measurement in order to spray the micro-organisms deposited thereon. The drawback is that this requires the sensor window to be adapted so that it does not break under the effect of the vibration. This approach therefore requires the sensor to be modified when it already exists, degrading not only its watertightness but also the accuracy and robustness of the measurement it performs. In addition, repeatedly vibrating the window can cause it to deform, as well as weaken the structure to which the window is attached.

There is therefore a need for an anti-biofouling system that can equip any immersed sensor.

### SUMMARY

An aspect of the invention offers a solution to the problems discussed previously, by providing a system for controlling biofouling by microorganisms which is adapted to cooperate with a measurement device without requiring modification of said measurement device.

An aspect of the invention thus relates to a system for controlling biofouling by microorganisms, adapted to cooperate with a measurement device to be immersed in a liquid, the measurement device comprising a fouling surface, the system being configured to cover the fouling surface, the system comprising:
a membrane;
an actuator, positioned on one of the faces of the membrane and able to vibrate the membrane, the actuator forming a pattern comprising an inner contour and an outer contour, the inner contour and the outer contour being concentric with a centre C, the inner contour having a minimum distance dᵢ from the centre C and the outer contour having a minimum distance dₑ from the centre C, the actuator being such that

$$0.2 \leq \frac{{d}_{i}}{{d}_{e}} \leq 0.4 .$$

By “measurement device”, it is meant equipment adapted to perform measurement of one or more properties, such as a sensor or probe. By way of example, it is an optical sensor (a fluorescence sensor, a camera, a laser, etc.), an oxygen sensor, a turbidity sensor or any other type of sensor whose component being used to detect the amount to be measured is not in contact with the liquid medium, especially by the presence of a viewport between the detection component and the liquid.

By “fouling surface”, it is meant a portion of the measurement device which, when said measurement device is not assembled with the system according to the invention, is in contact with the liquid. The fouling surface is therefore a surface on which fouling is desired to be avoided. By way of example, in the case where the measurement device is an optical sensor, the fouling surface is the sensor window through which the sensor performs its measurement. When this surface is fouled, the measurement by the optical sensor is incorrect.

By “to cover”, it is meant that the fouling surface is not in contact with the liquid medium when it is covered with the system according to the invention.

By “membrane”, it is meant a mechanical device able to be vibrated by an excitation generated by the actuator. In an embodiment, this membrane may have a thin thickness compared with its other dimensions, especially its length or diameter. The membrane can be circular, rectangular or any other shape adapted to the sensor.

By “actuator”, it is meant a device whose activation by an electrical signal allows the membrane to be vibrated. It is typically a thermal or piezoelectric actuator.

By “pattern”, it is meant a geometric shape formed by the actuator, especially formed on the membrane, in particular on the face of the membrane where the actuator is positioned.

By virtue of one or more aspects of the invention, it is possible to prevent deposition, adhesion and growth of aquatic microorganisms onto the membrane as well as on the fouling surface, when the system cooperates with the measurement device. In particular, by vibrating the membrane, the microorganisms can be expelled towards the periphery of the membrane in question.

This protection against biofouling is, furthermore, cleverly implemented with a membrane whose dimensions are determined so as to reduce vibration damping, and thus increase amplitude of displacement of the membrane, in order to improve detachment and spraying of microorganisms deposited thereon.

Tests have shown that such dimensioning of the actuator makes it possible to increase the amplitude of the deformation of the membrane by increasing the transduction coefficient between the actuator and the membrane. In addition, such dimensioning makes it possible to achieve large amplitudes of deformation of the membrane without the risk of damaging or breaking the actuator when it is actuated, which would typically be the case if the ratio between the minimum distances dᵢ and dₑ were less than 0.2, or even less than 0.3.

The system is additionally compatible with any technology of immersed measurement device. It is not necessary to adapt or modify the structure of the measurement device in order to assemble the system according to the invention with the measurement device.

Further to the characteristics just discussed, the system according to the invention may have one or more of the following additional characteristics, considered individually or according to any technically possible combination.

In an embodiment, the measurement device comprises an optical measurement sensor configured to emit an optical beam, wherein the membrane comprises a surface, referred to as the measurement surface, corresponding to a portion of the membrane through which the optical beam passes when the system cooperates with the measurement device, a centre of the measurement surface corresponds to the centre C of the inner contour and of the outer contour of the pattern formed by the actuator, and an internal surface area delimited by the inner contour is at least equal to 70% of the measurement surface area.

In an embodiment, the minimum distance dᵢ from the inner contour to the centre C is between 1 mm and 20 cm.

In an embodiment, the minimum distance dₑ from the outer contour to the centre C is between 1.5 mm and 25 cm.

In an embodiment, the actuator is configured to vibrate the membrane at an excitation frequency between 10 Hz and 1 kHz.

Vibrating the membrane at such a frequency allows the fundamental mode of the membrane to be excited and therefore the amplitude of displacement of this membrane to be maximised, thereby increasing spraying of the microorganisms deposited thereon. Tests have shown that this frequency range is particularly adapted to expel fouling that forms on the membrane.

Another interest of exciting the membrane in its fundamental mode of vibration is that it produces a single antinode, whose dimensions are the largest compared with the other modes of vibration. As a result, such excitation makes it possible to expel fouling from a same large size portion of the membrane. Beneficially, this portion can be used for measurement purposes by the measurement device, especially to enable the measurement device to make the measurement through this portion, which is therefore not or only slightly prone to fouling.

In an embodiment, the actuator comprises a plurality of disjoint actuation modules.

The interest of using several actuation modules, that is, several independent actuators, allows redundancy of the actuation mechanism and therefore allows the membrane to be actuated even if some of the actuation modules are faulty or inoperative.

In an embodiment, the membrane and the pattern formed by the actuator are of the same shape.

By “of the same shape”, it is meant that if the membrane is circular in shape then the pattern is circular in shape, for example annular, or that if the membrane is parallelepipedal in shape, for example a rectangle, then the pattern is parallelepipedal in shape, for example a rectangle.

In an embodiment, the membrane is circular in shape and the outer contour of the pattern formed by the actuator is located at a distance less than a predefined threshold distance from a contour of the membrane.

The actuator is therefore a “perimeter” actuator located on the perimeter of the surface of the membrane. For example, the predefined threshold distance is less than or equal to 10% of the distance between the contour of the membrane and the centre of the membrane.

In an embodiment, the actuator is configured to vibrate the membrane at an excitation frequency, the system further comprises an electronic circuit configured to determine a vibration frequency of the membrane and to modify the excitation frequency as a function of the determined vibration frequency.

It is thus possible to feedback control the excitation produced by the actuator on the membrane in order to correct the vibration frequency of the membrane, typically to make the membrane vibrate at the frequency of its fundamental mode of vibration. This feedback ensures that the membrane vibrates at its resonant frequency, at which the amplitude of deformation will be greatest, despite changing environmental restrictions that impact its resonant frequency, such as the movement of the liquid medium (for example swell, storm) or variations in immersion depth (for example due to waves or the tide).

Another aspect of the invention relates to a set comprising a measurement device and a biofouling control system according to the invention, wherein the fouling surface and the membrane are facing each other.

By “facing each other”, it is meant that the fouling surface and the membrane are assembled so as to be in front of each other, that is, to be face to face.

In an embodiment, the membrane has a maximum amplitude of displacement uₘₐₓ relative to a position at rest of the membrane along a direction normal to a surface of the membrane, and a distance L between the fouling surface and the membrane is such that L≥2uₘₐₓ.

By “maximum amplitude of displacement”, it is meant the maximum amplitude that the displacement of the membrane can have under the effect of vibration in a predefined range of excitation frequencies.

By “relative to as position at rest”, it is meant that the maximum amplitude of displacement corresponds to the maximum distance of this displacement, in either sense of the direction normal to the surface of the membrane, from the position at rest of the membrane, that is, the position without excitation of the membrane.

The distance d is thus large enough to ensure that the displacement of the membrane under the effect of excitation by the actuator will not come into contact with the fouling surface. This distance d is thus also large enough to avoid having too much pressure in the space between the membrane and the fouling surface which would damage the membrane, the actuator and/or the fouling surface.

In an embodiment, the membrane has two opposite faces, referred to as the front face and the rear face, the front face is intended to be in contact with the liquid, the set comprises a closed cavity at least partly delimited by the rear face of the membrane and by the fouling surface, a variation in pressure in the cavity is caused solely by the displacement of the membrane under the effect of its vibration.

In an embodiment, the fouling surface is a surface dedicated to measurement by the measurement device.

By “dedicated to measurement”, it is meant that the fouling surface does not significantly alter measurement by the measurement device. That is, the fouling surface is the portion of the measurement device via or through which the measurement is performed, such as a viewport for an optical sensor. In other words, it is the measurement interface of the measurement device with the liquid.

The invention and its different applications will be better understood upon reading the following description and upon examining the accompanying Figures.

### BRIEF DESCRIPTION OF THE FIGURES

Further characteristics and benefits of the invention will become apparent upon reading the description, which can be read in relation to the Figures. These Figures are set forth by way of indicating and in no way limiting purposes of the invention.

FIG. 1 comprises schematic representations of an anti-biofouling system, according to different embodiments of the invention.

FIG. 2 is a schematic representation of a membrane of the anti-biofouling system, according to an embodiment of the invention.

FIG. 3 is a schematic representation of a membrane of an anti-fouling system, according to several embodiments of the invention.

FIG. 4 is a schematic representation of a measurement device to be protected by the anti-fouling system, according to an embodiment of the invention.

FIG. 5 is a schematic representation of an alternative actuator for the system according to an embodiment of the invention.

FIG. 6 is a schematic representation of a set comprising the anti-fouling system and the measurement device, according to an embodiment of the invention.

FIG. 7 is a schematic representation of a displacement of the membrane, according to an embodiment.

FIG. 8 comprises two schematic representations of alternative embodiments of the set of FIG. 7.

### DETAILED DESCRIPTION

Unless otherwise specified, a same element appearing in different figures has a single reference.

The present invention is directed to a system designed to protect the fouling surface of a sensor, typically through which the sensor performs its measurements, against biofouling by aquatic microorganisms. The system provided is based on the use of a membrane which, when vibrated, expels the micro-organisms deposited thereon. The system is also adapted to be assembled with a sensor to insulate the fouling surface thereof from the liquid medium, thereby preventing deposition of microorganisms onto the fouling surface. The membrane is also adapted to allow measurement by the sensor through said membrane.

One aspect of the invention therefore relates to a system 10 for controlling biofouling by microorganisms, also called an anti-fouling system 10, as illustrated in the diagrams of FIG. 1.

The system 10 comprises a membrane 11 which can be vibrated by a mechanical excitation generated by an actuator 12.

The membrane 11 can be connected to a support 13, typically by embedding it at the perimeter of the membrane 11. That is, the membrane 11 is held in place by its perimeter being embedded in the support 13.

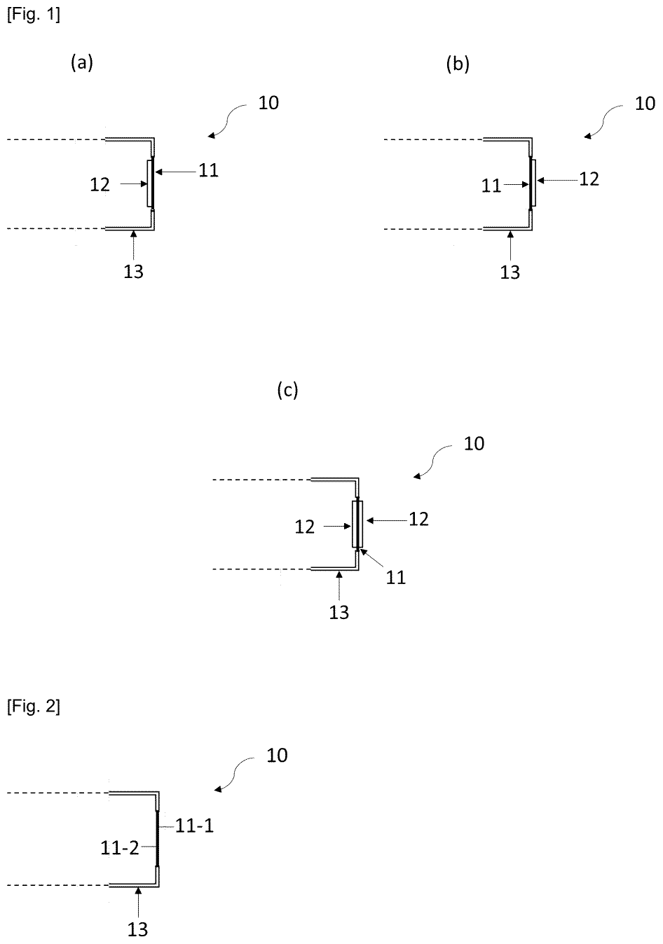

As illustrated in FIG. 2, the membrane 11 may comprise two opposite faces: a front face 11-1 and a rear face 11-2. The front face 11-1 points towards the liquid medium with which it is to come into contact. The rear face 11-2 points towards inside the system 10. When this system 10 is assembled with a measurement device, for example a sensor, this rear face 11-2 points towards the measurement device.

By “points towards”, it is meant that the face in question faces the object towards which it points, that is, that the face is oriented towards said object.

The membrane 11 has a thickness which is smaller than its other dimensions, especially compared with its length. Typically, the membrane is circular in shape, that is, the membrane is a disc, with a thickness of between 50 μm and 5 mm, typically between 50 μm and 500 μm, and a diameter of between 1 cm and 25 cm. Alternatively, the membrane is parallelepipedal in shape, typically a rectangle, with a thickness of between 5 μm and 5 mm, for example between 50 μm and 500 μm, and its length and/or width is at least greater than 1 cm, for example its length and/or width is between 1 cm and 25 cm.

The membrane 11 is comprised of a watertight material able to withstand pressures in a liquid medium up to 2 bar.

In an embodiment, the membrane 11 comprises a surface, referred to as the measurement surface 11-3, through which the measurement device can perform measurement. For example, in the case where the measurement device comprises an optical sensor, the optical beam emitted by the optical sensor passes through the measurement surface when the system cooperates with the measurement device. The measurement surface therefore corresponds to the portion of the membrane through which the optical beam passes when the system cooperates with the measurement device.

The measurement surface 11-3 of the membrane 11 therefore does not significantly alter measurement by the measurement device. That is, the material of the measurement surface 11-3 is such that the measurement surface 11-3 is transparent to the measurement by the measurement device. By “transparent”, it is meant that the presence of the membrane has a negligible influence on the measurement performed by the device. Typically, the measurement error induced by the presence of the membrane is less than or equal to 5% relative to a measurement performed in the absence of the system 10. For example, in the case of an optical sensor, the membrane leaves at least 70%, or even at least 90% of the optical beam to pass, at the transmission and/or reception wavelength of said sensor.

The measurement surface 11-3 may correspond to all or part of the surface of the membrane 11. For example, the measurement surface 11-3 area corresponds to at least 50%, at least 60%, at least 70%, even at least 80%, or even at least 90% of the surface area of the membrane 11.

In the example provided herein, the membrane 11 is of polycarbonate and has a thickness of 250 μm and a diameter of 2 cm. Alternatively, the membrane 11 can be of polyethylene naphthalate or polyethylene terephthalate, or any other transparent polymer.

The system 10 also comprises the actuator 12 being used to vibrate the membrane 11. The actuator 12 is positioned on one of the faces of the membrane 11. It is understood that the actuator 12 may be a single actuator, or a set of disjoint actuators (as in the example of FIG. 5).

In the example of FIG. 1 (a), the actuator 12 is on the rear face 11-2. In the example of FIG. 1 (b), the actuator 12 is on the front face 11-1. In the example of FIG. 1 (c), the system 10 comprises an actuator 12 on the rear face 11-2 and an actuator on the front face 11-1. When the actuator is on the front face, it is desirable to make it passive, that is, to insulate it from the liquid medium, for example by adding an insulating layer to the actuator or via any other known technology, especially to insulate its electrodes from the liquid.

In an alternative embodiment, the actuator 12 can have a same shape as the membrane. That is to say, if the membrane 11 is circular in shape, then the actuator 12 may also be circular or annular in shape. Alternatively, when the membrane 11 is parallelepipedal in shape, then the actuator 12 may also be parallelepipedal in shape, for example each may be rectangular in shape.

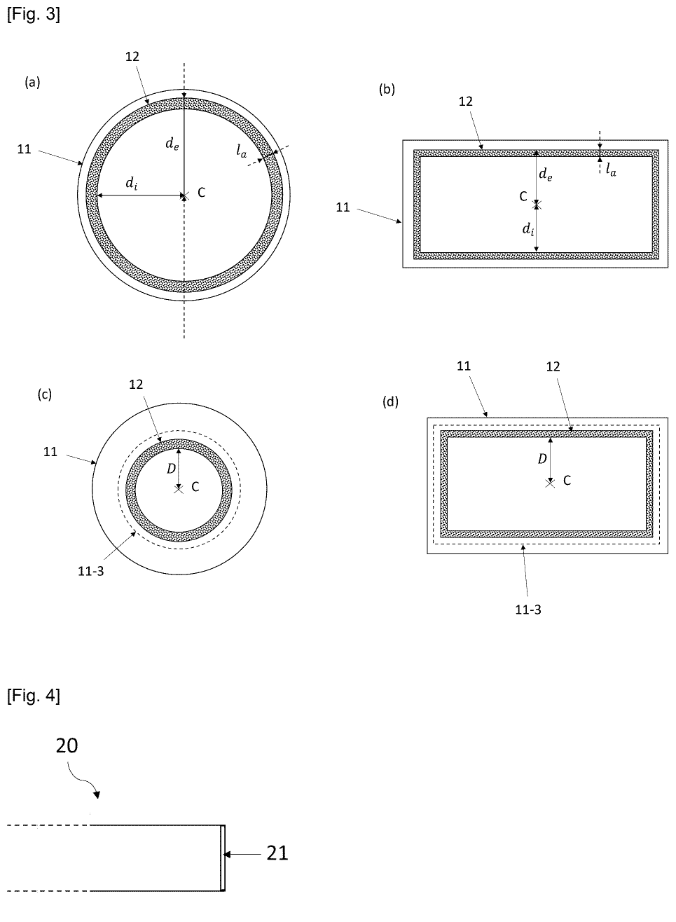

As represented in FIG. 3, the actuator 12 forms a pattern, that is to say, it forms a geometric shape on the membrane 11, in particular on the face on which it is positioned. This geometric shape formed by the actuator 12 is delimited by an inner contour and an outer contour. The pattern thus comprises the inner contour and the outer contour. The pattern is, for example, a continuous and/or regular geometric shape.

The pattern is, for example, a ring, as illustrated in FIG. 3 a), or a parallelepiped, such as a rectangle, as illustrated in FIG. 3 b).

The inner contour and the outer contour are concentric with the centre C.

In an alternative embodiment, the centre C is the same as the centre of the measurement surface 11-3. That is to say, the centre of the measurement surface corresponds to the centre C of the inner contour and the outer contour of the pattern formed by the actuator.

The inner contour of the actuator 12 has a minimum distance dᵢ from the centre C. This distance therefore corresponds to the radius of the internal perimeter of the actuator when it is annular, or to the smallest distance from the centre C to the inner contour of the actuator when it is parallelepipedal.

In an alternative embodiment, the measurement surface 11-3 is entirely contained within the surface delimited by the inner contour. Beneficially, in this way the measurement performed by the measurement device is not disturbed by the presence of the actuator 12.

The outer contour of the actuator 12 has a minimum distance dₑ from the centre C. This distance therefore corresponds to a radius, typically the smallest radius, of the external perimeter of the actuator when it is annular (for example circular or elliptical), or to the smallest distance from the centre C to the outer contour of the actuator when it is parallelepipedal.

The actuator 12 is such that

$$0.2 \leq \frac{{d}_{i}}{{d}_{e}} < 0.4 ,$$

for example such that

$$0.25 \leq \frac{{d}_{i}}{{d}_{e}} \leq 0.35 ,$$

typically in the order of

$$\frac{{d}_{i}}{{d}_{e}} = 0.3 .$$

The difference between the minimum distance dₑ of the outer contour and the minimum distance dᵢ of the inner contour is noted lₐ and is such that lₐ=dₑ−dᵢ. The difference lₐ therefore corresponds to the distance between the internal and external perimeters of the pattern formed by the actuator 12.

In other words, the actuator 12 is such that

$$0.2 \leq \frac{{d}_{i}}{{d}_{i} + {l}_{a}} < 0.4 ,$$

for example such that

$$0.25 \leq \frac{{d}_{i}}{{d}_{i} + {l}_{a}} \leq 0.35 ,$$

typically in the order of

$$\frac{{d}_{i}}{{d}_{i} + {l}_{a}} = 0.3 .$$

In an embodiment, the minimum distance dᵢ of the inner contour may be between 1 mm and 20 cm, for example between 1 mm and 2 cm, or even between 4 mm and 1 cm. The minimum distance dₑ of the outer contour may be between 1.5 mm and 25 cm, for example between 1.5 mm and 4.5 cm, or even between 6.5 mm and 2 cm.

In an embodiment, the difference lₐ may be between 0.5 mm and 5 cm, or even between 2.5 mm and 2 cm.

In an embodiment, a maximum distance between an edge of the actuator, for example the edge corresponding to the outer contour, and an edge of the membrane may be less than 5 mm or even 0.1 mm.

In an alternative embodiment, the edge corresponding to the outer contour lies beyond the portion of the membrane that is embedded in the system 10, especially embedded in the support 13.

Alternatively, in one alternative embodiment, the edge corresponding to the outer contour is on the membrane. This means that the actuator does not extend beyond the membrane but is, on the contrary, smaller than said membrane. In other words, the actuator is entirely on the membrane. As an example, when the membrane is a disc whose centre is the same as the centre C, the minimal distance dₑ is then smaller than the distance of the edge of the membrane to the centre C.

The actuator 12 is a thermal or piezoelectric actuator. For example, the actuator may be a piezoelectric ceramic made of lead titanate zirconates, also referred to as PZT.

In an embodiment, the material of the actuator 12 can be Polyvinylidene Fluoride.

The system 10 is adapted to cooperate with the measurement device, typically a sensor or probe. That is, the system 10 can be assembled with a measurement device. In particular, the support 13 of the system 10 is adapted to be assembled with the measurement device 20.

Any attachment system can be used to assemble the system 10 with the measurement device 20. For example, the attachment may be by push-fit, screw-nut, nailing, bonding, welding attachment, etc. It may be necessary to add systems of seals of Teflon, silicone or any other tight material known to the person skilled in the art.

A schematic representation of the measurement device 20 is provided in FIG. 4. The measurement device 20 comprises a fouling surface 21, which is in contact with the liquid when the measurement device 20 is not assembled with the system 10, that is, when the measurement device 20 and the system 10 are not cooperating.

The fouling surface 21 may be used to carry out the measurement, that is, the fouling surface may be a surface dedicated to measurement by the measurement device 20. For example, when the measurement device 20 is an optical sensor, the fouling surface 21 is a transparent viewport so that the sensor can emit and sense light waves through this fouling surface 21. In other words, the fouling surface 21 is used as an interface with the surrounding environment for the measurement device 20.

The fouling surface 21 may also be the detection surface of the measurement device 20, that is, it is sensitive to the physical quantity being measured. For example, in the case where the measurement device is an optical sensor 20 such as a camera, the fouling surface 21 may comprise one or more photosensitive cells in order to sense light coming from the surrounding medium.

The measurement device 20 is adapted to be immersed in a liquid. As such, it is watertight.

Since the system 10 is used to insulate the fouling surface 21 from the surrounding medium, herein the liquid, the system 10 is adapted to cover said fouling surface 21. In other words, the system 10 is designed to be assembled with the measurement device 20 so as to cover the fouling surface 21. The system 10 is therefore adapted so that the covering of the fouling surface 21 is watertight.

Attachment systems of the nut and clamping screw type can be used to attach the system 10 to the measurement device 20, thereby closing and making this assembly tight. These attachment systems can also be used to hold a seal disposed between the system 10 and the measurement device 20.

In an embodiment, the inner contour of the pattern formed by the actuator 12 delimits an inner surface, which is thus circumscribed by the inner contour. This inner surface corresponds to a hollowness in said actuator 12. In other words, the actuator 12 is hollowed out in its inner part, which corresponds to the surface delimited by the inner contour of the pattern formed by the actuator 12.

In this embodiment, the internal surface area delimited by the inner contour of the pattern formed by the actuator 12 is at least equal to 70%, for example at least equal to 80%, or even at least equal to 90%, of the measurement surface 11-3 area. That is to say, the area of this surface circumscribed by the inner contour is at least equal to 70%, for example at least equal to 80%, or even at least equal to 90%, of the area of the measurement surface 11-3.

In other words, the minimum distance dᵢ of the inner contour is greater than or equal to a predefined distance D. The predefined distance D, as illustrated in FIGS. 3 c) and d), is such that, when the minimum distance dᵢ is equal to the predefined distance D, the surface area delimited by the inner contour corresponds to at least 70%, for example at least 80% or even at least 90% of the measurement surface 11-3 area.

In other words, when the minimum distance dᵢ is equal to the predefined distance D, the hollowness of the actuator 12 allows the measurement device to perform a measurement at least through 70%, for example 80% or even 90%, of the measurement surface 11-3 area.

In other words, when the measurement device comprises an optical sensor, which is configured to emit an optical beam, the actuator 12 is dimensioned so as to leave at least 70%, for example 80% or even 90%, of the optical beam emitted by the optical sensor passing through the measurement surface to pass, especially atone or more wavelengths considered for the measurement. In this case, the measurement surface is transparent to the optical beam and has said optical beam passing therethrough when the system cooperates with the measurement device.

In an alternative embodiment, the actuator 12 can produce a vibration of the membrane 11 at an excitation frequency between 10 Hz and 1 kHz. The interest of this is to excite only the fundamental mode of deformation of the membrane.

In the example provided, the polycarbonate membrane, with a thickness of 250 μm and a diameter of 2 cm, has its fundamental mode of deformation which has a resonant frequency of 595 Hz at a depth of 50 cm below the level of liquid, herein water.

Thus, vibrating the membrane expels the micro-organisms which are deposited on a large portion of the membrane, at least in a portion of the membrane whose amplitude of displacement is at least greater than 20% of the maximum amplitude of displacement of the membrane relative to its position at rest.

In an alternative embodiment, as illustrated in FIG. 5, the actuator 12 can be a set of actuators 12-1 to 12-4. These actuators 12-1 to 12-4 are disjoint, that is, they are not in contact with each other. The set of actuators comprises at least two actuators.

The actuators 12-1 to 12-4 are disposed so that their arrangement forms a pattern on the membrane, such as a ring as illustrated in FIG. 5 a) or a parallelepiped, such as a rectangle illustrated in FIG. 5 b. In other words, the arrangement of the actuators 12-1 to 12-4 on the membrane 11 forms a split pattern on said membrane 11.

In other words, the actuators are positioned on this same pattern, which respects the restrictions imposed on the actuator 12 mentioned above. In particular, this pattern formed by the actuation modules has an inner contour and an outer contour, such that the inner contour has a minimum distance dᵢ from the centre C and such that the outer contour has a minimum distance dₑ from the centre C.

The actuators 12-1 to 12-4 are such that

$$0.2 \leq \frac{{d}_{i}}{{d}_{e}} < 0.4 ,$$

for example such that

$$0.25 \leq \frac{{d}_{i}}{{d}_{e}} \leq 0.35 ,$$

typically in the order of

$$\frac{{d}_{i}}{{d}_{e}} = 0.3 .$$

In other words, the pattern formed by the actuation modules has a difference lₐ between the minimum distance dₑ of the outer contour and the minimum distance dᵢ of the outer contour such that

$$0.2 \leq \frac{{d}_{i}}{{d}_{i} + {l}_{a}} < 0.4 ,$$

for example such that

$$0.25 \leq \frac{{d}_{i}}{{d}_{i} + {l}_{a}} \leq 0.35 ,$$

typically in the order of

$$\frac{{d}_{i}}{{d}_{i} + {l}_{a}} = 0.3 .$$

In this alternative, the ranges of values for the minimum distances dᵢ and dₑ and the width lₐ are the same as those indicated above.

In the example of FIG. 5 a), each of the actuators 12-1 to 12-4 has an arc of circle geometry, while in the example of FIG. 5 b) each of the actuators 12-1 to 12-4 has a rectilinear geometry.

In an alternative embodiment, the internal surface area delimited by the inner contour is at least equal to 70%, for example at least equal to 80%, or even at least equal to 90%, of the measurement surface 11-3 area. In other words, the minimum distance dᵢ of the inner contour of the pattern is greater than or equal to the predefined distance D, defined above.

In an alternative, the centre C of the pattern is the same as the centre of the measurement surface 11-3.

In an alternative embodiment, the system 10 may also comprise an electronic circuit configured to determine the vibration frequency of the membrane 11 by a method known per se, for example via a measurement of the impedance of the actuator 12.

The electronic circuit then makes it possible, via a feedback loop, to modify excitation generated by the actuator 12, in particular to modify excitation frequency. The electronic circuit is thus used to modify the frequency at which the membrane 11 vibrates in order to maximise its amplitude of displacement, especially by correcting said vibration frequency so that it corresponds to the frequency of the fundamental mode of deformation of the membrane 11.

The electronic circuit is therefore used to slave the frequency of the actuation signal delivered to the actuator 12 and used to actuate the membrane 11, that is, the excitation frequency, as a function of the vibration frequency determined.

This electronic circuit may comprise a processor, a microcontroller, a programmable electronic chip such as an FPGA (Field-Programmable Gate Array) chip, or any other electronic module able to determine the vibration frequency and modify the excitation frequency as a function of said vibration frequency.

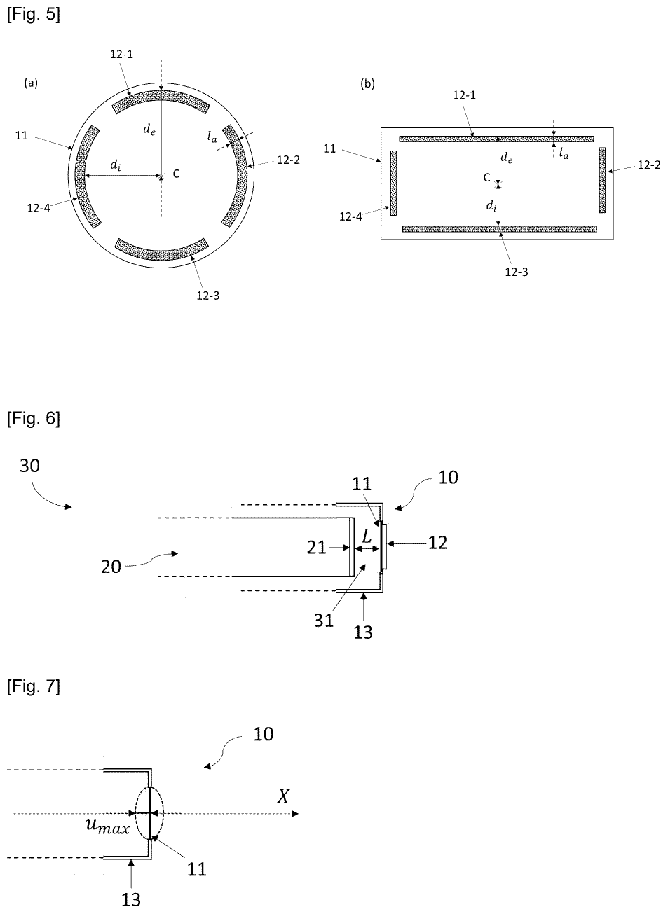

Another aspect of the invention, as illustrated in FIG. 6, relates to a set 30 comprising the system 10 and the measurement device 20, described above.

The actuator 12 is herein positioned on the front face 11-1 for the sake of clarity of the diagram of FIG. 6. The actuator 12 can indeed be positioned equally on either or both faces of the membrane 11.

The set 30 is such that the fouling surface 21 and the membrane 11 are facing each other. In other words, the measurement device 20 and the system 10 are assembled so that the fouling surface 21 and the membrane 11 are positioned face to face with each other.

In an alternative embodiment, as illustrated in FIG. 7, the membrane can have a maximum amplitude of displacement uₘₐₓ, relative to its position at rest, along a normal direction X to one of its faces.

The normal direction X corresponds to the direction of deformation of the membrane 11 under the effect of excitation by the actuator 12.

By “position at rest”, it is meant the position of the membrane when it is not vibrated by the excitation produced by the actuator. The maximum amplitude of displacement uₘₐₓ thus corresponds to the maximum difference in position reached by the membrane when it is vibrated by the actuator, relative to its position at rest.

The displacement of the membrane 11 is illustrated by the dotted arcs of circle on either side of the membrane 11.

Referring again to FIG. 6, the system 10 and the measurement device 20 are assembled in the set 30 such that there is a non-zero distance L between the fouling surface 21 and the membrane 11. The distance L may, alternatively, correspond to the distance between the fouling surface 21 and the rear face 11-2.

In this alternative embodiment, the set 30, that is, the assembly of the system 10 and the measurement device 20, typically via the support 13, may be such that the distance L satisfies the relationship L≥2uₘₐₓ.

For example, in the case where the membrane has a maximum vibration amplitude of 50 μm, then the distance L is greater than or equal to 100 μm.

In one alternative embodiment, illustrated in FIG. 6, the set 30 may comprise a closed cavity 31 between the membrane 11 and the fouling surface 21.

The cavity 31 is therefore at least partly delimited by the rear face 11-2 of the membrane 11 and by the fouling surface 21.

In this alternative embodiment, the pressure of the fluid contained in the cavity 31 can be only modified by the displacement of the membrane 11 when the same is vibrated by the actuator 12. In other words, a variation in pressure in the closed cavity 31 is caused solely by the displacement of the membrane 11 under the effect of its vibration.

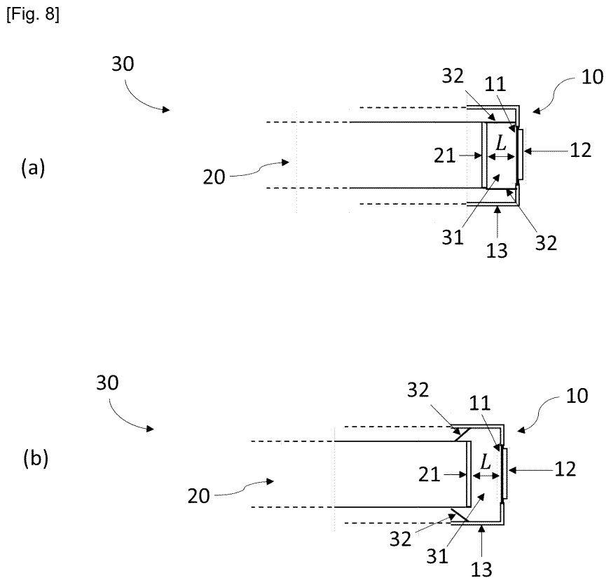

In an alternative embodiment, illustrated in FIG. 8 (a) and 8 (b), the set 30 may comprise a base 32, for example contained in the system 10, typically the base 32 is integral with the support 13.

The base 32 is used to circumscribe the cavity 31 between the membrane 11 and the fouling surface 21. The closed cavity 31 is therefore delimited by the membrane 11, the fouling surface 21 and the base 32. The base 32 is therefore adapted to cooperate with the measurement device 20 in order to close the cavity 31.

The base 32 can be attached to the support 13 so that the cavity 31 extends at least along the entire length of the rear face 11-2 of the membrane 11.

The actuator 12 is herein positioned on the front face 11-1 for the sake of clarity of the diagrams of FIG. 8. It is noted that the actuator 12 may be positioned on equally either or both faces of the membrane 11.

The positioning of the base 32 on the support 13 and relative to the measurement device 20 depends on the application in question and the geometrical characteristics of said measurement device 20. For example, the base 32 can be close to the membrane 11 and the fouling surface 21, as illustrated in FIG. 8 (a), or distant from the membrane 11 and the fouling surface 21, as illustrated in FIG. 8 (b). The positioning of the base 32 makes it possible to obtain a cavity 31 whose volume is more or less large, depending on the application in question.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The articles “a” and “an” may be employed in connection with various elements and components, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A person skilled in the art will readily appreciate that various features, elements, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

1. A system for controlling biofouling by microorganisms, adapted to cooperate with a measurement device to be immersed in a liquid, the measurement device comprising a fouling surface, the system being configured to cover the fouling surface, the system comprising:
a membrane;
an actuator positioned on a face of the membrane and able to vibrate the membrane, the actuator forming a pattern comprising an inner contour and an outer contour, the inner contour and the outer contour being concentric with a centre C, the inner contour having a minimum distance di from the centre C and the outer contour having a minimum distance de from the centre C, the actuator being such that
$$0.2 \leq \frac{{d}_{i}}{{d}_{e}} \leq 0.4 .$$

2. The system according to claim 1, wherein the measurement device comprises an optical measurement sensor configured to emit an optical beam, wherein the membrane comprises a surface, referred to as the measurement surface, corresponding to a portion of the membrane through which the optical beam passes when the system cooperates with the measurement device, wherein a centre of the measurement surface corresponds to the centre C of the inner contour and of the outer contour of the pattern formed by the actuator, and wherein an internal surface area delimited by the inner contour is at least equal to 70% of the measurement surface area.

3. The system according to claim 1, wherein the minimum distance dᵢ from the inner contour to the centre C is between 1 mm and 20 cm.

4. The system according to claim 1, wherein the minimum distance dₑ from the outer contour to the centre C is between 1.5 mm and 25 cm.

5. The system according to claim 1, wherein the actuator is configured to vibrate the membrane at an excitation frequency of between 10 Hz and 1 kHz.

6. The system according to claim 1, wherein the actuator comprises a plurality of disjoint actuation modules.

7. The system according to claim 1, wherein the membrane and the pattern formed by the actuator are of the same shape.

8. The system according to claim 1, wherein the actuator is configured to vibrate the membrane at an excitation frequency, the system further comprising an electronic circuit configured to determine a vibration frequency of the membrane and to modify the excitation frequency as a function of the determined vibration frequency.

9. A set comprising a measurement device and a biofouling control system according to claim 1, wherein the fouling surface and the membrane are facing each other.

10. The set according to claim 9, wherein the membrane has a maximum amplitude of displacement uₘₐₓ relative to a position at rest of the membrane along a direction normal to a surface of the membrane, and wherein a distance L between the fouling surface and the membrane is such that L≥2uₘₐₓ.

11. The set according to claim 9, the membrane having two opposite faces, referred to as the front face and rear face, the front face being intended to be in contact with the liquid, the set comprising a closed cavity at least partly delimited by the rear face of the membrane and by the fouling surface, wherein a variation in pressure in the cavity is caused solely by the displacement of the membrane under the effect of its vibration.

12. The set according to claim 9, wherein the fouling surface is a surface dedicated to a measurement by the measurement device.
